(19) United States
(12) Patent Application Publication
(10) Pub. No.: US 2013/0147918 A1
(43) Pub. Date: Jun. 13, 2013

(54) STEREO IMAGE GENERATION APPARATUS AND METHOD

(71) Applicant: Fujitsu Limited, Kawasaki-shi (JP)

(72) Inventors: Norihiro Kakuko, Kawasaki (JP); Teruyuki Sato, Tama (JP)

(73) Assignee: FUJITSU LIMITED, Kawasaki-shi (JP)

(21) Appl. No.: 13/708,086

(22) Filed: Dec. 7, 2012

(30) Foreign Application Priority Data
Dec. 9, 2011 (JP) 2011-270542

(51) Int. Cl. H04N 13/02

(52) U.S. Cl. CPC H04N 13/0203
USPC 348/46

(57) ABSTRACT

There is provided a stereo image generation apparatus which extracts a plurality of sets of feature points from each image of a subject formed in a left-half area and a right-half area captured using a stereo adapter such that feature points in each set correspond to the same one of points on the subject. The apparatus then calculates a set of correction parameters based on the sets of feature points and an evaluation value indicating a degree of likelihood of being correct feature point for a point with respect to a corresponding feature point extracted. For a given feature point of interest extracted from the one of the left-half and right-half areas, the evaluation value is high in a possible shifting area within which image shifting may occur due to distortion caused by the structure of the stereo adapter and the mounting potion error of the stereo adapter.

### CROSS-REFERENCE TO RELATED APPLICATION

This application is based upon and claims the benefit of priority of the prior Japanese Patent Application No. 2011-270542, filed on Dec. 9, 2011, the entire contents of which are incorporated herein by reference.

### FIELD

The embodiments discussed herein are related to a stereo image generation apparatus and a stereo image generation method.

### BACKGROUND

Research and development activities have been made to realize a technique of reproducing a three-dimensional image. One method of reproducing a three-dimensional image is to take two images of a subject from different directions and display the resultant two images side by side such that one of the two images is viewed by one of two eyes of a user and the other is viewed by the other eye. A pair of images used in such a manner is called a stereo image.

To generate a stereo image, a stereo adapter may be attached to the front end of a monocular camera lens thereby making it possible to form two images of a subject seen from different directions on an image plane of the camera such that one image is formed in a left-hand area and the other in a right-hand area of the image plane (see, for example, Japanese Laid-open Patent Publication No. 1996-036229 and Japanese Laid-open Patent Publication No. 2004-101666). The stereo adapter includes two pairs of mirrors disposed, for example, line symmetrically with respect to a horizontal center of the stereo adapter such that the camera is capable of forming two images of a subject seen from two different directions. An inner-side mirror of each mirror pair is located in front of the imaging lens such that a reflecting surface thereof faces the imaging lens and such that the reflecting surface is tilted from the optical axis of the imaging lens to the horizontal direction. On the other hand, an outer-side mirror of each mirror pair is spaced away in a horizontal direction from the imaging lens and away outwardly from the corresponding inner-side mirror. A light beam coming from a subject is reflected by the outer-side mirror and then further reflected by the inner-side mirror toward the imaging lens such that subject images seen from the two respective outer-side mirrors are formed in a left-half area and a right-half area of the image plane of the imaging lens. Areas including subject images are extracted from the left-half and right-half areas of the image of the subject captured using the stereo adapter, and employed as an image for a left eye and an image for a right eye thereby obtaining a stereo image.

Two images in the stereo image are supposed to be respectively viewed by left and right eyes of a human observer, and thus, to reproduce a high-quality three-dimensional image, it is desirable that two images formed in the respective half areas of the total area are captured under similar conditions to those under which a human observer sees an object. On the other hand, it is desirable that the stereo adapter is configured such that a range of an image formed in the left-half area and a range of an image formed in the right-half area overlap each other as much as possible at a particular distance (for example, 2 m) from the camera to the subject. To this end, the mirrors are positioned such that a main light beam which comes from the subject and is reflected by the outer-side mirrors is tilted from the optical axis of the imaging lens. As a result, images of the subject formed on the respective half areas have distortion. For example, in the image of the subject generated by the mirror pair located on the left side with respect to the imaging lens, the distance from a point on an object plane parallel to the image plane of the imaging lens to the imaging lens decreases as the point in the object plane is located farther away to the left from the center, and thus the image size is greater on the left side than on the right side, i.e., the image of the subject is distorted into a trapezoidal form. Conversely, in the image of the subject generated by the mirror pair located on the right side with respect to the imaging lens, the image of the subject is distorted into a trapezoidal form such that the image size is greater on the right side than on the left side.

When the stereo adapter is mounted on the front end of the imaging lens, if there is a mounting error from a correct mounting position, the mounting error leads to a change in difference in terms of distortion and a position between the image formed in the left-half area and the image formed in the right-half area.

To reproduce a high-quality three-dimensional image using a stereo image, it is desirable that there is high similarity as possible in terms of distortion and a position between the image formed in the left-half area and the image formed in the right-half area. In view of the above, in a known technique, a plurality of sets of feature points are determined such that one of feature points in each set is on the image for left eye and the other one is on the image for right eye and such that both feature points in each set correspond to the same point on the subject, and the images on the two half areas are aligned based on the sets of feature points (see, for example, Japanese Laid-open Patent Publication No. 2004-354256). The positions of respective pixels of at least one of the images of the two half areas are converted according to position correction parameters defining a projection transform matrix calculated based on the plurality of sets of feature points (see, for example, “Image Analysis Handbook”, edited by Mikio TAKAGI and Haruhisa SHIMODA, University of Tokyo Press, 1991, pp. 584-585).

### SUMMARY

According to an aspect of the invention, a stereo image generation apparatus includes a subject area extraction unit configured to extract, from an image, a first area including a first image of the subject generated by one of two light beams and a second area including a second image of the subject generated by the other one of the two light beams, the image being captured by using a stereo adaptor configured to split light from the subject into two light beams and direct the two light beams to the image capturing unit, a feature point extraction unit configured to extract a plurality of sets of feature points from the first area and the second area such that each set of feature points corresponds to the same one of points on the subject, a correction parameter calculation unit configured to calculate, based on the plurality of sets of feature points, at least one correction parameter according to which aligns the image of the subject on the first area and the image of the subject on the second area with respect to each other, a correction unit configured to correct, using the correction parameter, either one of both of the image of the subject on the first area and the image of the subject on the second area thereby generating a stereo image, wherein the feature point extraction unit is configured to extract the sets of feature points by extracting a first feature point from the first area, determining a position on the image of the subject in the second area to which the image of the subject in the first area is shifted depending on a coordinate of the first feature point and depending on a structure of the stereo adapter and defining the position as a base point, defining a possible shifting area within which further shifting from the base point due to a positioning error in mounting the stereo adapter on the image capturing unit may occur on a point on the image of the subject in the second area in addition to the shifting from a corresponding point on the image of the subject in the first area due to the structure of the stereo adapter, calculating an evaluation value for a plurality of points in the second area according to an evaluation function which is high when a point of interest exits within the possible shifting area and which increases with increasing similarity of the point of interest with a neighboring area of the first feature point, detecting a point having a highest evaluation value and employing the detected point as a second feature point, and combining the first feature point and the second feature point into a set thereby obtaining the set of feature points.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a structure of a digital camera including a stereo image generation apparatus.

FIG. 2 is a schematic diagram illustrating a relationship between a structure of a stereo adapter and an image of a subject included in a total image.

FIGS. 3A and 3B are diagrams illustrating an example of a relationship between a relative position of a stereo adapter with respect to an image capturing unit and distortion that occurs on an image of a subject included in a total image generated by the image capturing unit.

FIG. 4 is a diagram illustrating a configuration of a stereo image generation apparatus according to a first embodiment.

FIG. 5 is a diagram illustrating an example of a relationship between an image of a subject included formed in a left-half area and an image of the subject formed in a right-half area.

FIG. 6A is a diagram illustrating directions in which points on a subject are shifted due to distortion of an image of the subject formed in a left-half area caused by a structure of a stereo adapter, FIG. 6B is a diagram illustrating directions in which points on the subject are shifted due to distortion of the image of the subject formed in the right-half area caused by the structure of the stereo adapter, and FIG. 6C is a diagram illustrating directions in which points on the image of the subject image formed in the left-half image are shifted to corresponding points of the image of the subject in the right-half area.

FIG. 7 is a diagram illustrating a possible shifting area within which a shift may occur from a point on a subject image in the left-half image to a corresponding point on a subject image in the right-haft image due to a mounting position error of a stereo adapter.

FIG. 8 is a flow chart illustrating a process of generating a stereo image.

FIG. 9 is a diagram illustrating a configuration of a stereo image generation apparatus according to a second embodiment.

FIGS. 10A and 10B are diagrams illustrating a relationship between a distribution of feature points and an unevenness degree.

FIG. 11 is a diagram illustrating a configuration of a stereo image generation apparatus according to a third embodiment.

FIG. 12 is a diagram illustrating a configuration of a stereo image generation apparatus according to a fifth embodiment.

FIG. 13 is a diagram illustrating a configuration of a computer that operates as a stereo image generation apparatus by executing a computer program to implement functions of the stereo image generation apparatus according to one of embodiments or modifications thereto.

### DESCRIPTION OF EMBODIMENTS

### Problems

However, as described above, when an image is captured using a stereo adapter, there is a difference in distortion between an image of a subject formed in a left-half area of total image area and an image of the subject formed in a right-half area. Therefore, there is a possibility that the shape of the image of the subject in a vicinity of a feature point extracted from one of the two half areas may be similar not to a vicinity of a point on the other half area corresponding to the feature point but to a vicinity of a different point. This may produce a possibility that a feature point in one of half areas corresponding to a point on the subject is erroneously related to a wrong feature point in the other one of half areas corresponding to a different point on the subject. In this case, a correction parameter may be inadequate.

In view of the above, the embodiments discussed herein are related to a stereo image generation apparatus capable of calculating a correction parameter that allows an increase in alignment accuracy between two images of a subject formed in respective half areas of the total image area captured using a stereo adapter.

A stereo image generation apparatus is described below with reference to various embodiments and various modifications thereto in conjunction with drawings. The stereo image generation apparatus extracts a plurality of sets of feature points from an image of a subject formed in a left-half area captured using a stereo adapter and an image of the subject formed in a right-half area such that feature points in each set correspond to the same one of points on the subject. The stereo image generation apparatus then calculates a set of correction parameters based on the sets of feature points. In the calculation, the stereo image generation apparatus calculates an evaluation value indicating a degree of likelihood of being correct feature point for a point with respect to a corresponding feature point extracted from one of the two left-half and right-half areas such that the evaluation value is calculated for each point in the other one of the left-half and right-half areas. For a given feature point of interest extracted from the one of the left-half and right-half areas, the evaluation value is high in a possible shifting area within which image shifting may occur due to distortion caused by the structure of the stereo adapter and the mounting potion error of the stereo adapter. For each given feature point of interest extracted from one of the left-half and right-half areas, the stereo image generation apparatus detects a point having a highest evaluation value in the other one of the left-half and right-half areas, and combines the given feature point of interest and the detected point with the highest evaluation value into a set of feature points corresponding to the same one of points on the subject. This allows a reduction in the probability that the stereo image generation apparatus erroneously relates wrong feature points such that a feature point in the one of left-half and right-half areas corresponding to one of points on the subject is related to a feature point in the other one of the left-half and right-half area corresponding to a different one of the points on the subject, thereby achieving an improvement in accuracy of correction parameters.

In the present embodiment, the stereo image generation apparatus is embedded in a digital camera, a portable telephone with camera, a portable information terminal with camera, or the like, configured such that it is allowed to mount a stereo adapter thereon.

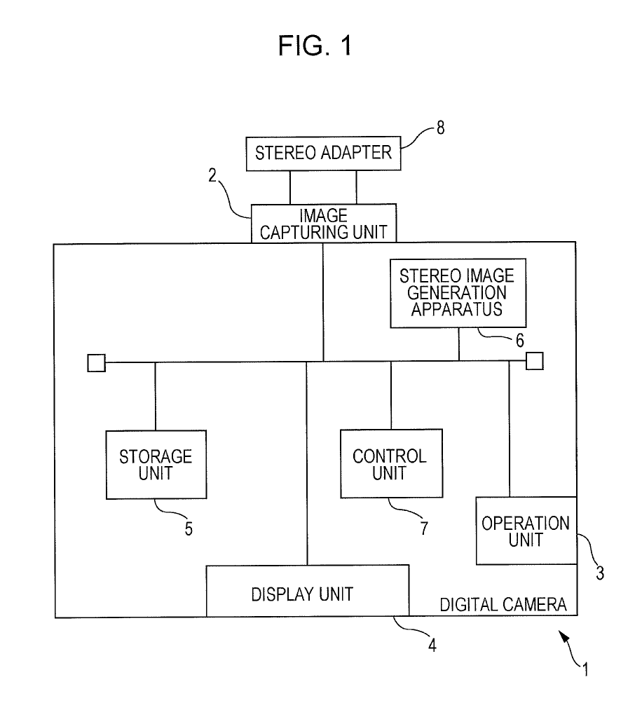

FIG. 1 is a schematic diagram illustrating a structure of a digital camera including the stereo image generation apparatus. As illustrated in FIG. 1, a digital camera 1 is an example of a stereo image generation apparatus and includes an image capturing unit 2, an operation unit 3, a display unit 4, a storage unit 5, a stereo image generation apparatus 6, and a control unit 7. The image capturing unit 2 includes an imaging lens system, and a stereo adapter 8 is attached to a front end of the imaging lens system. The digital camera 1 may further include an interface circuit (not illustrated in FIG. 1) according to a serial bus standard such as the universal serial bus for connection with a device such as a computer, a deletion receiver, or the like. In the digital camera 1, the control unit 7 is connected to other units via, for example, a bus.

The image capturing unit 2 includes an image sensor including an array of solid-state image sensor elements arranged in a two dimensional form, an imaging optical system that forms, via the stereo adapter 8, an image of a subject on the image sensor such that the image of the subject is formed in both a left-half area and right-half area of the image sensor. The image capturing unit 2 generates an image including a left-half area and a right-half area in both of which an image of the subject is formed. Each time the image capturing unit 2 generates an image, the generated image is transmitted to the stereo image generation apparatus 6.

The operation unit 3 includes, for example, various operation buttons or dial switches for use by a user to operate the digital camera 1. In response to an operation performed by the user, the operation unit 3 sends a control signal to the control unit 7 to start image capturing operation or a focusing operation or a setting signal to make setting in terms of a shutter speed, an aperture value, or the like.

The display unit 4 includes a display device such as a liquid crystal display device for displaying various kinds of information received from the control unit 7 or an image generated by the image capturing unit 2. Note that the operation unit 3 and the display unit 4 may be formed in an integral fashion using, for example, a touch panel display.

The storage unit 5 includes, for example, a volatile or nonvolatile read-write semiconductor memory circuit. The storage unit 5 stores a stereo image generated by the stereo image generation apparatus 6. The storage unit 5 may store an image received from the image capturing unit 2. In a case where functions of the stereo image generation apparatus 6 are implemented by a computer program that is executed on a processor included in the control unit 7, the computer program may be stored in the storage unit 5.

From the image of the subject captured using the stereo adapter 8, the stereo image generation apparatus 6 extracts a left-half image area including a subject image as a for-left-eye image and extracts a right-half image area including a subject image as a for-right-eye image. In the following description, for convenience of illustration, the for-left-eye image will be referred to simply as the left image and the for-right-eye image will be referred to simply as the right image. The stereo image generation apparatus 6 determines a set of correction parameters for use in aligning a subject image included the left image and the subject image included in the right image with each other. The stereo image generation apparatus 6 then corrects at least one of the left image and the right image using the set of correction parameters. The details of the stereo image generation apparatus 6 will be described later.

The control unit 7 includes at least one processor and its peripheral circuit. The control unit 7 controls the whole digital camera 1.

The stereo adapter 8 includes a mounting mechanism (not illustrated in FIG. 1) for mounting the stereo adapter 8 on the front end of the image capturing unit 2 and also includes two pairs of mirrors for forming images of a subject seen in different two directions on the image plane of the image capturing unit 2.

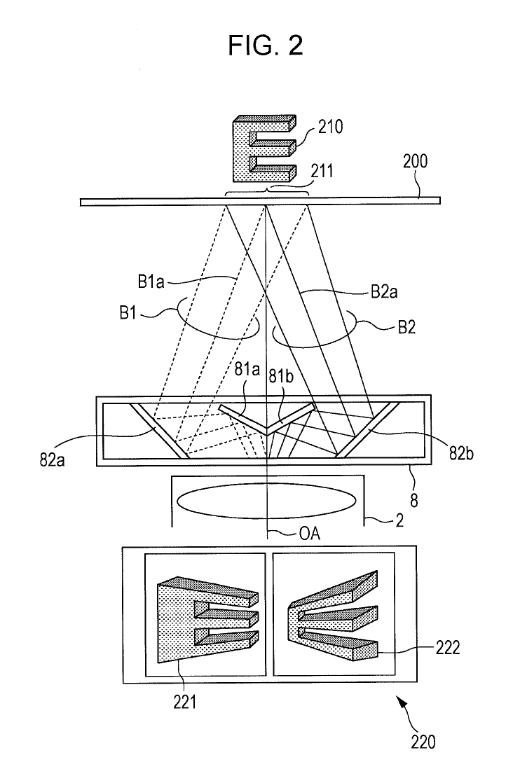

FIG. 2 is a schematic diagram illustrating a relationship between a structure of the stereo adapter 8 and images of a subject on a total image generated by the image capturing unit 2. As illustrated in FIG. 2, the stereo adapter 8 includes therein for-left-eye mirrors 81a and 82a and for-right-eye mirrors 81b and 82b. The for-left-eye mirrors 81a and 82a and the for-right-eye mirrors 81b and 82b are located line symmetrically with respect to a horizontal center of the stereo adapter 8 mounted on the digital camera 1. The mirrors 81a and 81b are disposed in front of the imaging optical system of the image capturing unit 2 such that reflecting surfaces face the image capturing unit 2 and the reflecting surfaces are tilted from an optical axis OA of the imaging optical system. On the other hand, the mirrors 82a and 82b are disposed at locations shifted in outward directions from the locations of the mirrors 81a and 81b such that reflecting surfaces thereof faces an object plane 200. The mirrors 82a and 82b reflect light beams B1 and B2 coming from a subject 210 located in the object plane 200 toward the mirrors 81a and 81b. The light beams B1 and B2 are further reflected by the mirrors 81a and 81b and are incident on the imaging optical system of the image capturing unit 2. The orientation of each mirror is adjusted such that an image of an area 211 including the subject 210 is formed in both a left-half area and a right-half area of the image sensor of the image capturing unit 2. As a result, a main light beam Bla of the light beam B1 from the subject 210 to the mirror 82a and a main light beam B2a of the light beam B2 from the subject 210 to the mirror 82b are tilted from the optical axis OA.

In FIG. 2, an image 221 of the subject 210 is formed by the light beam B1 in the left-half area of the image 220 generated by the image capturing unit 2, while an image 222 of the subject 210 is formed by the light beam B2 in the right-half area of the image 220. The optical path length of the light beam B1 from the subject 210 to the image capturing unit 2 decreases as the point on the subject 210 is located closer to the left-hand end of the subject 210. This causes the image 221 of the subject 210 to be distorted into a trapezoidal form whose left-hand side is greater than the right-hand side. Conversely, the optical path length of the light beam B2 from the subject 210 to the image capturing unit 2 decreases as the point on the subject 210 is located closer to the right-hand end of the subject 210. This causes the image 222 of the subject 210 to be distorted into a trapezoidal form whose right-hand side is greater than the left-hand side.

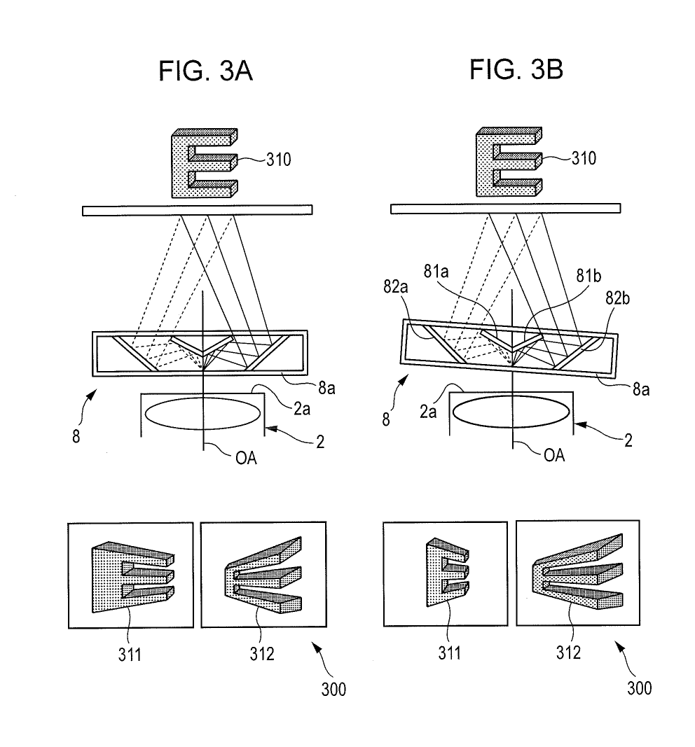

Referring to FIG. 3A and FIG. 3B, an explanation is given below as to an example of distortion that occurs on an image of a subject generated by the image capturing unit 2 depending on a relative position between the stereo adapter 8 and the image capturing unit 2. In an example illustrated in FIG. 3A, the stereo adapter 8 is properly mounted on the image capturing unit 2 such that a back surface 8a of the stereo adapter 8 is parallel to the front end 2a of the image capturing unit 2 and the horizontal center of the stereo adapter 8 is coincident with the optical axis OA of the imaging optical system of the image capturing unit 2. In this case, an image 311 of a subject 310 formed in a left-half area of a total image 300 generated by the image capturing unit 2 has a horizontal width equal to the horizontal width of an image 312 of the subject 310 formed in a right-half area of the total image 300.

On the other hand, in an example illustrated in FIG. 3B, the stereo adapter 8 is mounted at a slant on the image capturing unit 2 such that the gap between the front end 2a of the image capturing unit 2 and the back surface 8a of the stereo adapter 8 increases with the location from right to left of the stereo adapter 8. As a result, the subject 310 is viewed at a more tilted angle by the optical system including the left-hand mirrors 81a and 82a than viewed by the optical system including the right-hand mirrors 81b and 82b, and thus the horizontal width of the image 311 is smaller than that of the image 312. If the center position of the stereo adapter 8 as seen in the horizontal direction is deviated from the optical axis OA, this causes the positions of the image 311 and the image 312 on the image 300 to be deviated correspondingly in the horizontal direction.

As described above, the distortion and the position of the image of the subject formed in the left-half area of the total image relative to the distortion and the position of the image formed in the right-half area of the total image vary depending on the structure of the stereo adapter 8 and the positioning error of the stereo adapter 8 with respect to the image capturing unit 2. Therefore, the stereo image generation apparatus 6 aligns the two images of the subject with each other taking into account the difference in distortion and position between the two images of the subject formed on the total image.

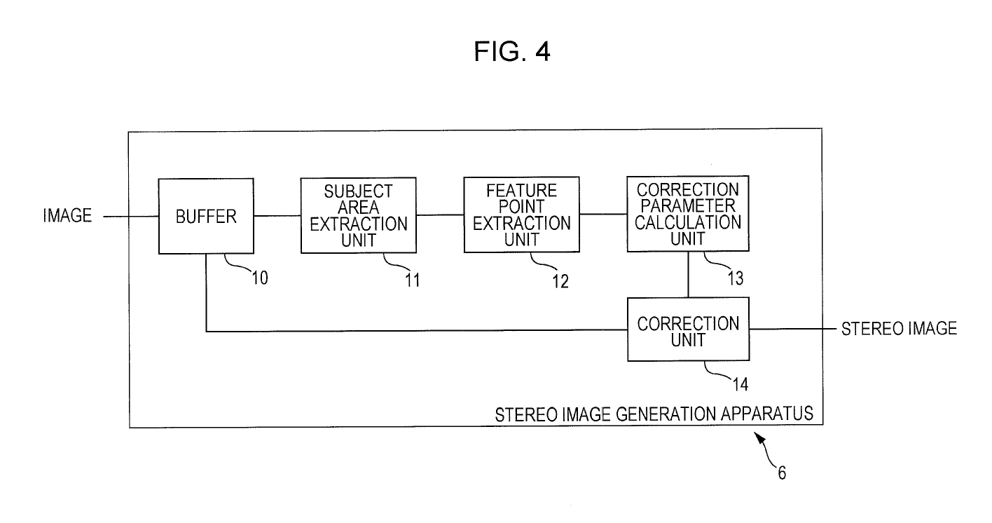

The stereo image generation apparatus 6 is described in further detail below. FIG. 4 illustrates a configuration the stereo image generation apparatus 6. As illustrated in FIG. 4, the stereo image generation apparatus 6 includes a buffer 10, a subject area extraction unit 11, a feature point extraction unit 12, a correction parameter calculation unit 13, and a correction unit 14. These units of the stereo image generation apparatus 6 may be individually realized in separate circuits and may be mounted in the stereo image generation apparatus 6 or the units may be realized on a single chip of an integrated circuit.

Alternatively, the stereo image generation apparatus 6 may be formed integrally with the control unit 7. In this case, for example, the above-described units in the stereo image generation apparatus 6 may be implemented as functional modules realized by executing a computer program on a processor in the control unit 7. Various kinds of data generated by the stereo image generation apparatus 6 or used by the stereo image generation apparatus 6 are stored in the storage unit 5.

The buffer 10 includes, for example, a volatile semiconductor memory circuit therein to temporarily store an image input to the stereo image generation apparatus 6 and a left image and a right image extracted by the subject area extraction unit 11.

The subject area extraction unit 11 reads out the image generated by the image capturing unit 2 from the buffer 10 and extracts an area including a subject image from each of the left-half area and the right-halt area of the total image thereby generating a left image and a right image. More specifically, for example, the subject area extraction unit 11 may set areas in which a subject image is expected to exist, in the left-half area and the right-half area of the total image, and may extract the areas set in the above-described manner as a left image and a right image.

Although a subject and a neighboring area on an image are bright, vignetting produced by the stereo adapter 8 may cause other areas to receive substantially no light, i.e., such other areas become dark. To avoid the above problem, the subject area extraction unit 11 may determine a set of pixels with luminance higher than a predetermined threshold value in the left-half area of the total image, and may define a rectangular area having a particular size such that the center of the rectangular area is located at the barycenter of the set of pixels. The subject area extraction unit 11 then cuts out this rectangular area as a left image. Similarly, the subject area extraction unit 11 may determine a set of pixels with luminance higher than the predetermined threshold value in the right-half area of the total image, and may cut out, as a right image, a rectangular area which has a particular size and the center of which is located at the barycenter of the set of pixels. The threshold value may be, for example, the mean value of luminance over the total image. Alternatively, in a luminance histogram, a range from the bottom to a particular level in which 10% to 30% of pixels of the total image exist, and a luminance value corresponding to this particular level may be employed as the threshold value. In a case where the size of an image area in which no vignetting occurs is known, this size may be employed as the particular size of the rectangular area.

The subject area extraction unit 11 stores the left image and the right image in the buffer 10.

The feature point extraction unit 12 reads out the left image and the right image from the buffer 10 and extracts a plurality of sets of feature points from the left image and the right image such that each set corresponds to the same one of points on the subject.

As described above, the distortion of the subject image formed in the left image is different from that in the right image. Therefore, a subject image in the vicinity of a feature point extracted from one of the left image area and the right image area may be similar in shape to an subject image in the other area at a location different from a location corresponding to feature point.

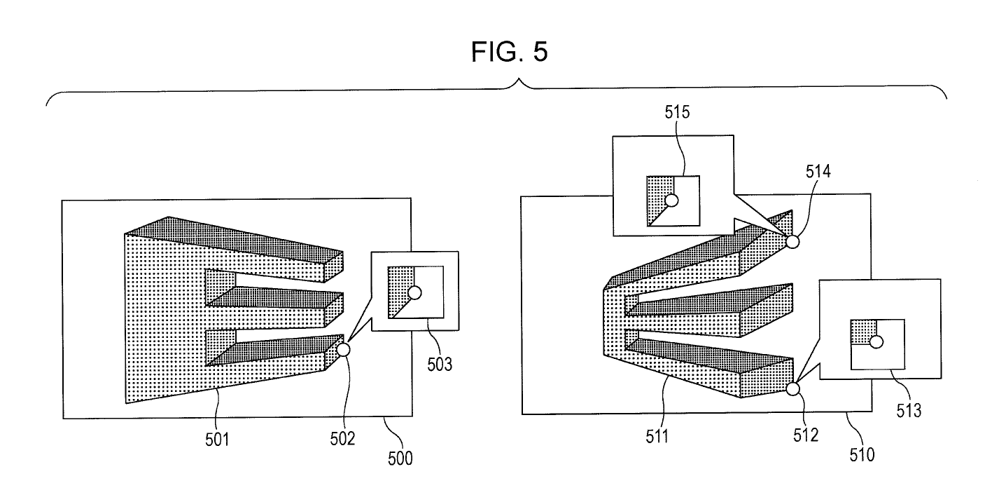

FIG. 5 illustrates an example of a relationship between a subject image in the left image and that in the right image. In FIG. 5, in a case wherein a lower right corner 502 of a subject image 501 in a left image 500 is extracted as a feature point, the corner 502 has an obtuse form as illustrated in an inset 503. On the other hand, a lower right corner 512 of a subject image 511 in a right image 510 has a right angle as illustrated in an inset 513. Instead, an upper right corner 514 of the subject image 511 is obtuse as illustrated in an inset 515. As a result, the vicinity of the corner 514 is more similar than the vicinity of the corner 512 to the vicinity of the lower right corner 502 of the image 501 on the left image 500. Therefore, if the whole right image 510 is searched to seek a feature point corresponding to the lower right corner 502 of the image 501 on the left image, then there is a possibility that the corner 514 is erroneously detected as a corresponding feature point. In view of the above, to correctly extract pairs of corresponding feature points, it is desirable that the feature point extraction unit 12 take into account a direction and a distance of shift from an subject image on one of the left image and the right image to that on the other one where the direction and the distance of shift depend on the structure of the stereo adapter 8 and the positioning error of the stereo adapter 8.

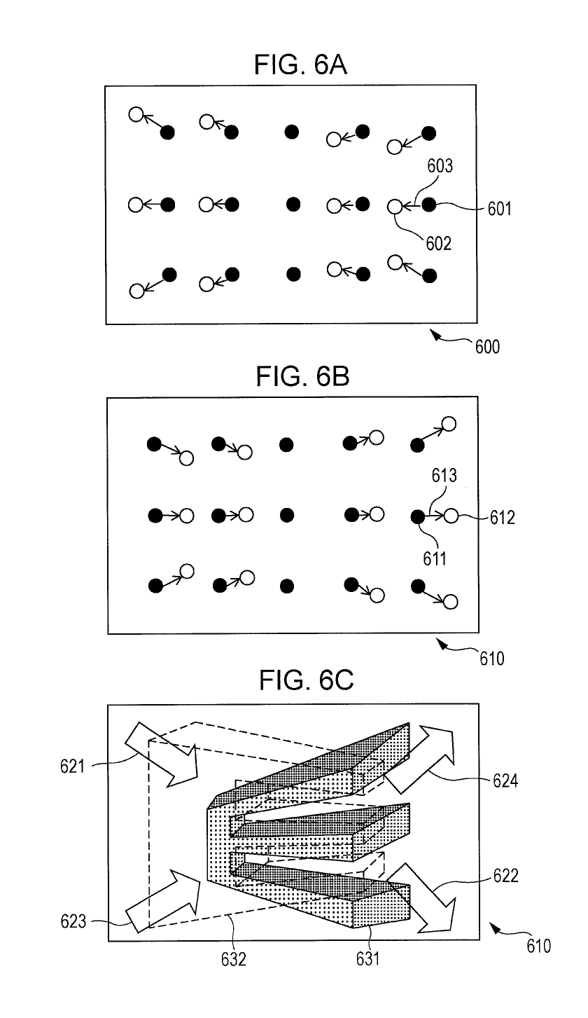

FIG. 6A illustrates directions of shifts of points on a subject that occur as a result of distortion of a subject image on the left image caused by the structure of the stereo adapter 8. FIG. 6B illustrates directions of shifts of points on the subject that occur as a result of distortion of a subject image on the right image caused by the structure of the stereo adapter 8. FIG. 6C illustrates directions of shifts of points on the subject image on the right image with respect to corresponding points on the subject image on the left image.

In FIG. 6A, solid circles 601 on the left image 600 indicate points on the subject image when the image has no distortion, while open circles 602 indicate points on the subject image having distortion caused by the structure of the stereo adapter 8. Arrows 603 indicate directions and distances of shifts of the subject image caused by the distortion. As illustrated in FIG. 6A, in a right-hand area of the left image 600, the distortion causes points on the subject image to shift from right to left in a horizontal direction, while in terms of a vertical direction, the distortion causes points to shift toward a center of the left image 600. On the other hand, in a left-hand area of the left image 600, the distortion causes points on the subject image to shift from right to left in the horizontal direction, while in terms of the vertical direction, the distortion causes points to shift in directions away from the center of the left image 600. Note that the amount of shift increases with increasing distance from the center of the left image 600.

Similarly, in FIG. 6B, solid circles 611 on a right image 610 indicate points on the subject image when the image has no distortion, while open circles 612 indicate points on the subject image having distortion caused by the structure of the stereo adapter 8. Arrows 613 indicate directions and distances of shifts of the subject image caused by the distortion. In a right-hand area of the right image 610, conversely to the left image, the distortion causes points on the subject image to shift from left to right in the horizontal direction, while in terms of the vertical direction, the distortion causes points to shift in directions away from a center of the right image 610. On the other hand, in a left-hand area of the right image 610, the distortion causes points on the subject image to shift from left to right in the horizontal direction, while in terms of a vertical direction, the distortion causes points to shift toward the center of the right image 610. Also in the right image 610, the amount of shift increases with increasing distance from the center of the right image 610.

Thus, in FIG. 6C, as indicated by an arrow 621 and an arrow 622, in upper left and lower right areas of the right image 610, points on the subject image 631 shift in a lower right direction with respect to corresponding points of the subject image 632 on the left image. On the other hand, in lower left and upper right areas of the right image 610, as indicated by an arrow 623 and an arrow 624, points on the subject image 631 shift in an upper right direction with respect to corresponding points of the subject image 632 on the left image.

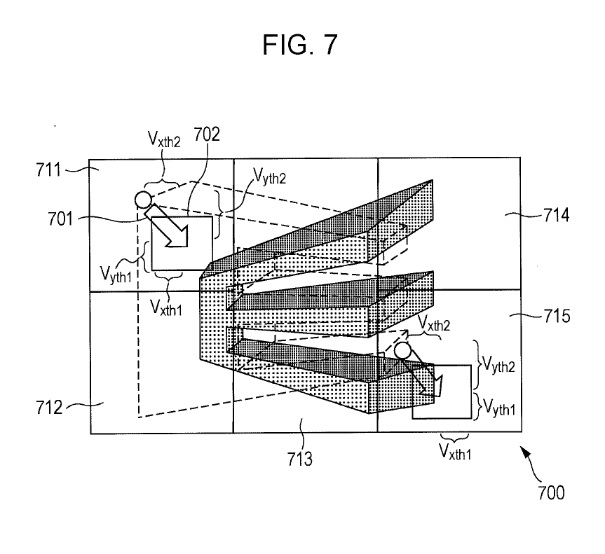

FIG. 7 illustrates a possible shifting area within which a shift may occur from a point on a subject image on the left image to a corresponding point on a subject image on the right image due to a mounting position error of the stereo adapter 8. Variations, due to the mounting position error of the stereo adapter 8, in terms of shifting direction and amount of shift from a point on the subject image on the left image to a corresponding point on the subject image on the right image fall into a particular range corresponding to a maximum possible value of the mounting error. Note that the mounting position error may cause the subject image to shift not only in a horizontal direction but also in a vertical direction. Therefore, a point on the subject image on the right image corresponding to a point on the subject image on the left image is likely, with a high probability, to exist within a rectangular area 702 which has a particular width and a particular height and the center of which is at a location to which the subject image is shifted as indicated by an arrow 701 in FIG. 7 due to the structure of the stereo adapter 8.

In view of the above, for example, the feature point extraction unit 12 extracts feature point candidates from one of the left image and the right image. The feature point extraction unit 12 then calculates an evaluation value for various points on the other one of the left image and the right image according to an evaluation function which is high when a point of interest is within a possible maximum shifting area within which shifting due to a mounting potion error of the stereo adapter 8 may occur from a base point which is a shifted position caused by the structure of the stereo adapter and which increases with increasing similarity of the point in terms of a structure to the vicinity of the feature point candidate. The feature point extraction unit 12 detects a point having a highest evaluation value and employs the detected point as a feature point on the other image corresponding to the feature point candidate on the one image.

The feature point extraction unit 12 extracts a plurality of feature point candidates, for example, from the left image. More specifically, for example, the feature point extraction unit 12 detects a plurality of points by applying a corner detector to the left image and employs the detected points as feature point candidates. An example of a corner detector usable for the above purpose is a Harris detector. Note that the feature point extraction unit 12 may use a detector other than the corner detector to detect characteristic points thereby extracting feature point candidates from the left image. More specifically, for example, the feature point extraction unit 12 may employ a Scale-invariant feature transform (SIFT) detector as the detector.

The feature point extraction unit 12 then defines an area with a particular size around each feature point candidate extracted from the left image and employs the defined area as a template. The feature point extraction unit 12 determines the evaluation value representing the likelihood of being a feature point by performing template-matching while changing the relative position between the template and the right image, according to an evaluation function described below.

e(x,y,vₓ,v_{y})=s(x,y,vₓ,v_{y})+α·fₛₜₑₚ(vₓₜₕ₁−|vₓ−vₓₜₕ₂|)+β·fₛₜₑₚ(v_{yth1}−|v_{y}−vₓₜₕ₂|) (1)

e(x,y,vₓ,v_{y})=s(x,y,vₓ,v_{y})+α·fₛₜₑₚ(vₓₜₕ₁−|vₓ|)+β·fₛₜₑₚ(v_{yth1}−|v_{y}|) (2)

Equation (1) is an evaluation function to be applied when the feature point candidate is located within one of the following regions: a first partial area at the upper left or lower right corner of the left image; a predetermined area at the lower left corner of the left image; or a second partial area at the upper right corner. Equation (2) is an evaluation function to be applied when the feature point candidate is located within a third partial area including the center of the left image. In Equations (1) and (2), (x, y) represents a horizontal and vertical coordinates of the feature point candidate, (x+vₓ, y_{y}+v_{y}) represents coordinates of a point shifted from (x, y) by vₓ in the horizontal direction and by v_{y} in the vertical direction on the right image, and s(x, y, vₓ, v_{y}) represents similarity of an area around the point (x+v, y+v_{y}) on the right image with respect to the template. More specifically, for example, the similarity s(x, y, vₓ, v_{y}) may be given by a normalized cross-correlation value between the template and the area around the point (x+vₓ, y+v_{y}). A function fₛₜₑₚ(a) is a step function that outputs a relatively large value, for example, a maximum allowable value of the similarity s(x, y, vₓ, v_{y}) or 1 when a variable a is equal to or greater than 0, while the function fₛₜₑₚ(a) outputs a relatively small value, for example, a minimum allowable value of the similarity s(x, y, vₓ, v_{y}) or 0 when the variable is a smaller than 0. vₓₜₕ₁ and v_{yth1} respectively represent maximum possible shifts, in horizontal and vertical directions, from the subject image on the left image to the subject image on the right image due to a mounting position error of the stereo adapter 8. vₓₜₕ₂ and v_{yth2} respectively represent shifts, in horizontal and vertical directions, from the subject image on the left image to the subject image on the right image due to the structure of the stereo adapter 8. In the present embodiment, a coordinate system on the left image is defined such that an origin is set on a pixel located at the upper left corner of the left image and directions are defined such that a horizontal positive direction is taken from the origin to the right while a vertical positive direction is taken from the origin to a downward direction. In this case, within the first partial area, vₓₜₕ₂>0 and v_{yth2}>0. On the other hand, in the second partial area, vₓₜₕ₂>0 and v_{yth2}<0. α and β are positive coefficients. More specifically, for example, 0<α and β<1. Note that a may or may not be equal to β. In the function fₛₜₑₚ(a), e(x, y, vₓ, v_{y}) is an evaluation value on the point (x+vₓ, y+v_{y}).

Referring again to FIG. 7, to set the first to third partial areas, for example, a right image 700 is divided equally into three partial areas in a horizontal direction and each of leftmost and right most partial areas is further divided into two partial areas in a vertical direction. As a result, five partial areas 711 to 715 are set in the right image 700. Of these partial areas, the upper left partial area 711 and the lower right partial area 715 are set as the first partial areas. The lower left partial area 712 and the upper right partial area 714 are set as the second partial areas. The central partial area 713 is set as the third partial area.

For each feature point candidate, the feature point extraction unit 12 detects a point having a highest evaluation value on the right image and employing the detected point as the feature point on the right image corresponding to the feature point candidate on the left image. More specifically, for example, for a given feature point candidate of interest, the feature point extraction unit 12 may calculate evaluation values for all pixels of the right image according to Equation (1) or (2) and may employ a pixel having a maximum evaluation value as a feature point. Alternatively, for a given feature point candidate of interest, the feature point extraction unit 12 may employ a corresponding pixel on the right image as a first searching point. The feature point extraction unit 12 may then determine evaluation values for the searching point and 8 or 24 neighboring pixels according to Equation (1) or (2) and selects a pixel having the largest evaluation value as a next searching point. The feature point extraction unit 12 performs the above-described process repeatedly until the searching point stays at the same position, and the feature point extraction unit 12 employs the finally determined searching point as a feature point. Alternatively, the feature point extraction unit 12 may determine a feature point using a fact that the evaluation function given by Equation (1) or (2) has a maximum value when partial derivatives of the evaluation function with respect to vₓ and v_{y} are equal to 0. In this case, more specifically, for a given feature point candidate of interest, the feature point extraction unit 12 may differentiate partially the right side of Equation (1) or (2) with respect to vₓ and v_{y} and may determine solutions for the partial derivatives=0.

According to a modification, vₓₜₕ₂ and v_{yth2} in Equation (1) may be determined for each pixel on the left image. In this case, the evaluation value may be calculated according to Equation (1) for all feature point candidates. Preferably, vₓₜₕ₂ and v_{yth2} may be determined such that the absolute values of vₓₜₕ₂ and v_{yth2} increase with increasing distance from the center of the left image. In a partial area located left to and upper than the center of the left image or a partial area located right to and lower than the center of the left image, vₓₜₕ₂ and v_{yth2} are determined such that vₓₜₕ₂>0 and v_{yth2}>0. On the other hand, in a partial area located left to and lower than the center of the left image or a partial area located right to and upper than the center of the left image, vₓₜₕ₂ and v_{yth2} are determined such that vₓₜₕ₂>0 and v_{yth2}<0. At the center of the left image, vₓₜₕ₂ and v_{yth2} are determined such that vₓₜₕ₂=v_{yth2}=0. Values of vₓₜₕ₂ and v_{yth2} at respective coordinates are stored, for example, in a memory of the feature point extraction unit 12 in relation to corresponding coordinates on the left image. The feature point extraction unit 12 selects values of vₓₜₕ₂ and v_{yth2} used in Equation (1) depending on coordinates of each feature point candidate. In this modification, vₓₜₕ₁ and v_{yth1} may be equal for all pixels on the left image.

If the maximum value of the evaluation value e(x, y, vₓ, v_{y}) described above is equal to or greater than a predetermined threshold value, the feature point extraction unit 12 employs a set of the feature candidate point (x, y) on the left image and the point (x+vₓ, y+v_{y}) on the right image as a set of feature points corresponding to the same point on the subject.

On the other hand, when the maximum value of the evaluation value e(x, y, vₓ, v_{y}) described above is smaller than the predetermined threshold value, the feature point extraction unit 12 determines that the right image does not have a feature point that matches the template corresponding to the feature point candidate. In this case, this feature point candidate may be discarded. The higher the predetermined threshold value is, the higher the degree of likelihood that the set of feature points determined by the feature point extraction unit 12 correspond to the same point on the subject. For example, the predetermined threshold value may be set to be equal to the maximum allowable value of the evaluation value times a factor of 0.8 to 0.9. Alternatively, the feature point extraction unit 12 may increase the threshold value with the number of feature point candidates extracted from the left image. This allows the feature point extraction unit 12 to extract only sets of feature points that are likely to correspond to the same point when the number of feature point candidates extracted from one of the images is large. Conversely, even when the number of feature candidates extracted from one of images is small, the feature point extraction unit 12 is capable of extracting a sufficiently large number of sets of feature points to determine an adequate correction parameter. The feature point extraction unit 12 sends values of horizontal and vertical coordinates of the two feature points on the image to the correction parameter calculation unit 13 for each of the obtained sets of feature points.

The correction parameter calculation unit 13 calculates a set of correction parameters for use in correcting a subject image included in at least one of the left image and the right image to make registration between the subject image on the left image and that on the right image.

The differences in terms of the position of the subject image and the distortion between the left image and the right image may be corrected by performing a projective transformation on the image of at least the left image or the right image so as to obtain an image virtually seen from the same direction as the direction in which the other image is seen in capturing the image. The projective transformation may be performed, for example, according to an equation described below.

$$[ \begin{matrix}u \\ v \\ 1\end{matrix} ] = {ARA}^{- 1} [ \begin{matrix}x \\ y \\ 1\end{matrix} ] \\ [ \begin{matrix}{x}^{′} \\ {y}^{′} \\ 1\end{matrix} ] = Rz [ \begin{matrix}u - W / 2 \\ v - H / 2 \\ 1\end{matrix} ] + T \\ R = [ \begin{matrix}1 & 0 & 0 \\ 0 & cos {θ}_{x} & sin {θ}_{x} \\ 0 & - sin {θ}_{x} & cos {θ}_{x}\end{matrix} ] [ \begin{matrix}cos {θ}_{y} & 0 & sin {θ}_{y} \\ 0 & 1 & 0 \\ cos {θ}_{y} & 0 & cos {θ}_{y}\end{matrix} ] , \\ A = [ \begin{matrix}f & 0 & 0 \\ 0 & f & 0 \\ 0 & 0 & 1\end{matrix} ] \\ Rz = [ \begin{matrix}cos {θ}_{z} & - sin {θ}_{z} & 0 \\ sin {θ}_{z} & cos {θ}_{z} & 0 \\ 0 & 0 & 1\end{matrix} ] , T = [ \begin{matrix}W / 2 \\ H / 2 \\ 0\end{matrix} ] \qquad ( 3 )$$

where (x, y) denotes horizontal and vertical coordinates of a point of interest on the image to be corrected (the left image in this specific example), (x′, y′) denotes horizontal and vertical coordinates of the point of interest on the image after the correction, θₓ and θ_{y} respectively denote rotation angles in horizontal and vertical directions of the optical axis of the imaging optical system corresponding to the image under correction with respect to the optical axis of the imaging optical system corresponding to the image that is not subjected to the correction, θ_{z} denotes a rotation angle of the image under correction about the rotation center taken on the optical axis of the imaging optical system corresponding to the image that is not subjected to the correction, and f denotes a focal length of the imaging optical system corresponding to the image subjected to the correction and that of the imaging optical system corresponding to the image not subjected to the correction, while in the present embodiment, f is the focal length of the imaging optical system of the image capturing unit 2. Coordinates of a point on the image corresponding to a point at which the optical axis of the imaging optical system intersects an image plane are given by (W/2, H/2) where W is the horizontal width and H is the vertical height of the image. Thus, the correction parameters are given by parameters θₓ, θ_{y}, and θ_{z}. Alternatively, the correction parameter calculation unit 13 may employ 9 elements in a 3×3 matrix of the projective transformation as correction parameters. Alternatively, the correction parameter calculation unit 13 may normalize all 9 elements of the 3×3 projection transform matrix such that one of non-zero elements becomes equal to 1 and may employ the remaining 8 elements as correction parameters.

The correction parameter calculation unit 13 may determine the parameters θₓ, θ_{y}, and θ_{z}, for example, using the least-square method. More specifically, the correction parameter calculation unit 13 takes the parameters θ_{X}, θ_{y}, and θ_{z} as variables and transforms coordinates of feature points of at least one of the left image and the right image according to Equation (3) for each set of feature points. The correction parameter calculation unit 13 then determines the square of the distance between transformed feature points. Thereafter, the correction parameter calculation unit 13 determines the mean square value of distances overs all sets of feature points. The correction parameter calculation unit 13 detects parameters θₓ, θ_{y}, and θ_{z} which allow the mean square value to take a minimum value, and employs the detected parameters θₓ, θ_{y,} and θ_{z} as a set of correction parameter. In the present embodiment, the correction parameter calculation unit 13 determines a set of correction parameters (θₓ, θ_{y}, θ_{z}) for use in the projective transformation on the left image according to Equation (3). Alternatively, the correction parameter calculation unit 13 may determine a set of correction parameters (θₓ, θ_{y}, θ_{z}) for use in the projective transformation on the right image according to Equation (3). The correction parameter calculation unit 13 sends the set of correction parameters (θₓ, θ_{y}, θ_{z}) to the correction unit 14.

Using the calculated set of correction parameters, the correction unit 14 corrects at least one of the subject image on the left image and the subject image on the right image thereby generating a stereo image. In the present embodiment, the correction unit 14 corrects the position of each pixel of the left image according to an equation obtained by applying the set of correction parameters to Equation (3). A stereo image is provided by a set of the obtained left image and the corresponding right image. The correction unit 14 may correct the positions of respective pixels of the right image instead of correcting the positions of respective pixels of the left image. In this case, the correction unit 14 replace the set of correction parameters (θₓ, θ_{y}, θ_{z}) in Equation (3) by (−θₓ, −θ_{y}, −θ_{z}). The correction unit 14 may correct the positions of pixels of both the left image and the right image according to Equation (3). In this case, a set of correction parameters applied to the left image may be given by (θₓ/2, θ_{y}/2, θ_{z}/2) while a set of correction parameters applied to the right image may be given by (−θₓ/2, −θ_{y}/2, −θ_{z}/2). The stereo image generation apparatus 6 displays the obtained stereo image on the display unit 4 or stores the stereo image in the storage unit 5.

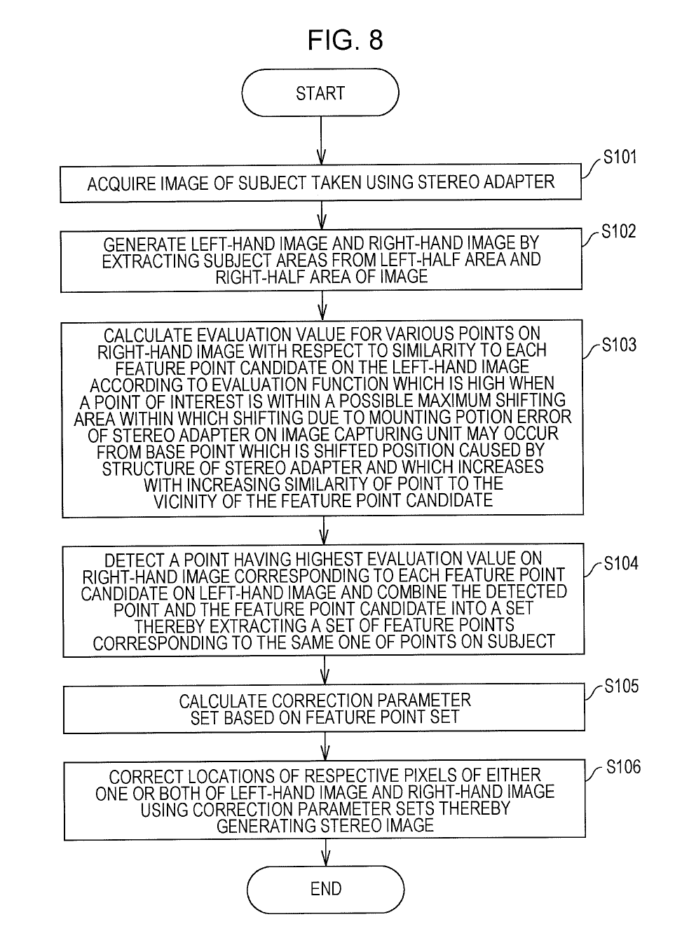

FIG. 8 is a flow chart illustrating a process of generating a stereo image performed by the stereo image generation apparatus 6. The stereo image generation apparatus 6 acquires, from the image capturing unit 2, an image of a subject captured using the stereo adapter 8 (step S101). The stereo image generation apparatus 6 stores the acquired image in the buffer 10. The subject area extraction unit 11 reads out the image from the buffer 10 and extracts subject areas from a left-half area and a right-half area of the total image thereby generating a left image and a right image (step S102). The subject area extraction unit 11 stores the resultant left image and the right image in the buffer 10.

The feature point extraction unit 12 reads out the left image and the right image from the buffer 10 and extracts a plurality of feature point candidates from the left image. For each feature point candidate on the left image, the feature point extraction unit 12 calculates an evaluation value indicating the degree of likelihood of being a corresponding feature point for various points on the left image (step S103). Note that, as described above, the evaluation value is high when the point subjected to the evaluation is in the possible shifting area which depends on the structure of the stereo adapter 8 and the mounting position error of the stereo adapter 8, and the evaluation value increases with increasing similarity with a vicinity of the feature point candidate. The feature point extraction unit 12 then detects a point having a highest evaluation value among the points on the right image for each feature point candidate on the left image, and combines the detected point and the corresponding feature point candidate into a set of feature points corresponding to the same point on the subject (step S104). The feature point extraction unit 12 sends coordinates of each feature point in each set to the correction parameter calculation unit 13.

The correction parameter calculation unit 13 calculates a set of correction parameters based on the sets of feature points (step S105). The correction parameter calculation unit 13 sends the set of correction parameters the correction unit 14.

The correction unit 14 reads out the left image and the right image from the buffer 10 and corrects the positions of pixels of at least one of the left image and right image using the set of correction parameters thereby generating a stereo image (step S106). The stereo image generation apparatus 6 outputs the generated stereo image, and thus the stereo image generation process is complete.

As described above, the stereo image generation apparatus extracts feature point sets each corresponding to the same one of points on a subject from a left image and a right image extracted from a total image of a subject captured using the stereo adapter. In this process, the stereo image generation apparatus extracts feature point sets taking into account the shifting direction and the amount of shift which are dependent on the structure of the stereo adapter and the mounting position error of the stereo adapter. This makes it possible to suppress the probability that the stereo image generation apparatus selects two feature points corresponding to different points on the subject erroneously as a set of feature points corresponding to the same point on the subject. As a result, the stereo image generation apparatus is capable of determining a set of correction parameters that allow it to correct positions with improved accuracy.

Next, a stereo image generation apparatus according to a second embodiment is described below. In this embodiment, the stereo image generation apparatus judges whether a calculated set of correction parameters is adequate for use in generating a stereo image. Only when the judgment is affirmative, a correction is made on a subject image of at least one of a left image and a right image using the set of correction parameters.

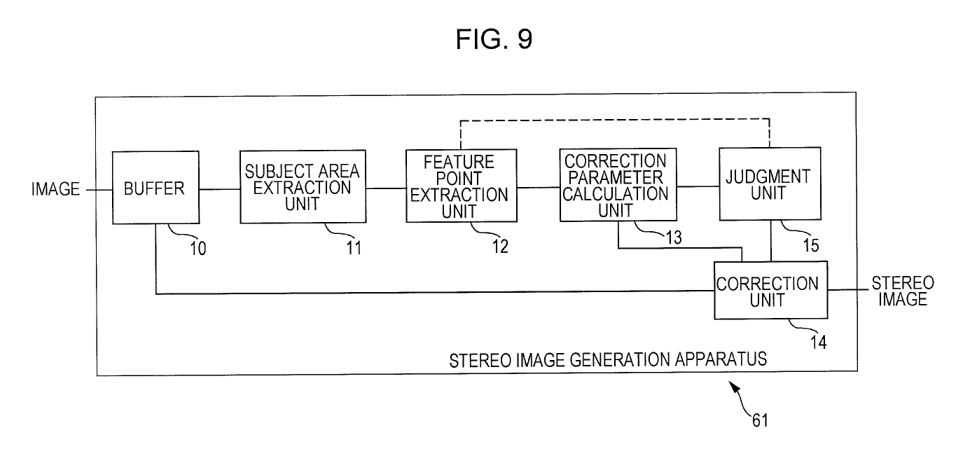

FIG. 9 illustrates a configuration of a stereo image generation apparatus according to the second embodiment. The stereo image generation apparatus 61 according to the second embodiment includes a buffer 10, a subject area extraction unit 11, a feature point extraction unit 12, a correction parameter calculation unit 13, a correction unit 14, and a judgment unit 15. In FIG. 9, similar elements of the stereo image generation apparatus 61 to those of the stereo image generation apparatus 6 according to the first embodiment illustrated in FIG. 4 are denoted by similar reference numerals. The stereo image generation apparatus 61 according to the second embodiment is different from the stereo image generation apparatus 6 according to the first embodiment in terms of the judgment unit 15. Therefore, the following description focuses on the judgment unit 15 and associated parts. As to elements of the stereo image generation apparatus 61 other than the judgment unit 15, refer to descriptions of corresponding elements of the stereo image generation apparatus according to the first embodiment.

The judgment unit 15 judges whether a set of correction parameters calculated by the correction parameter calculation unit 13 is adequate for use in generating a stereo image.

For the above purpose, the judgment unit 15 receives the set of correction parameters from the correction parameter calculation unit 13. The judgment unit 15 transforms coordinates of feature points of a left image by using the set of correction parameters and determines a correction error which is statistic in terms of distances between transformed feature points on the left image and corresponding feature points on a right image. More specifically, for example, the judgment unit 15 calculates the mean value of absolute values of or the mean square value of distances between feature points of respective feature point sets and employs the calculated mean value as the correction error. The judgment unit 15 then determines whether the correction error is equal to or smaller than a predetermined threshold value. When the correction error is greater than the threshold value, the judgment unit 15 judges that the set of correction parameters is not adequate for use in generating the stereo image, and the judgment unit 15 instructs the correction unit 14 to discard the set of correction parameters. The stereo image generation apparatus 6 may send a signal to the control unit 7 of the digital camera 1 to notify that an adequate set of correction parameters is not obtained. On receiving the signal, the control unit 7 may display a message on the display unit 4 to prompt a user to again take an image. The stereo image generation apparatus 6 may acquire the retaken image from the image capturing unit 2 and may again determine a set of correction parameter based on the newly obtained image.

On the other hand, in a case where the correction error is equal to or smaller than the predetermined threshold value, the judgment unit 15 judges that the set of correction parameters is adequate for use in generating a stereo image and notifies the correction unit 14 of this judgment result. On receiving the notification, the correction unit 14 corrects at least either the positions of the subject image on the left image or the positions of the subject image on the right image according to the set of correction parameters thereby producing a stereo image.

The threshold value in terms of the correction error may be set to an upper limit of an allowable range of the correction error within which a three-dimensional image displayed according to the stereo image generated using the set of correction parameters has acceptable high image quality. The upper limit of the correction error, i.e., the threshold value in terms of the correction error may be, for example, experimentally determined by producing a correction error and a stereo image based on a plurality of sample data of a set of a left image and a right image.

Alternatively, the judgment unit 15 may determine an unevenness degree indicating a degree of unevenness in distribution of feature points and may use the unevenness degree in judging whether a set of correction parameters is adequate for use in generating a stereo image.

When the unevenness degree of feature point distribution is high, this means that a set of correction parameters is determined based on a particular local area of a left image and a particular local area of a right image. Therefore, there is a high probability that a set of correction parameters determined based on such feature points is not capable of accurately correcting pixel positions over an entire image. Therefore, the unevenness degree is a measure to judge whether a set of correction parameters is adequate for use in generating a stereo image. In the present embodiment, the judgment unit 15 determines the unevenness degree based on a plurality of feature points on the right image. Alternatively, the judgment unit 15 may determine the unevenness degree based on a plurality of feature points on the left image.

For example, the judgment unit 15 may equally divide the right image in a horizontal direction into m blocks and in a vertical direction into n blocks thereby setting m×n blocks, where m and n are integers one of which is equal to or greater than 2 and the other is equal to or greater than 1. For example, m and n are set such that m=n=3. The judgment unit 15 then determines the number of feature points existing in each of the blocks. The judgment unit 15 further determines the number of blocks including no feature point or including a less number of feature points than a predetermined value, and the judgment unit 15 employs this number as the unevenness degree. The predetermined value may be set to equal to ⅕ to 1/10 of the average number of feature points existing blocks or may be set to a fixed value such as 1 to 3.

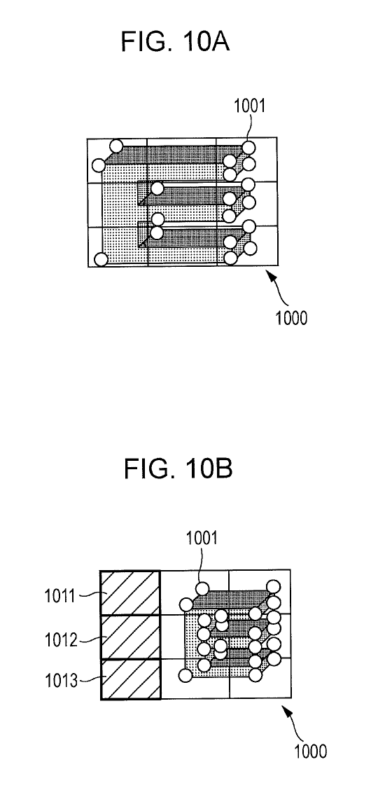

Referring to FIG. 10A and FIG. 10B, evenness in distribution f feature points is further discussed. In FIG. 10A and FIG. 10B, an image 1000 is divided into 3×3 blocks. A plurality of open circles 1001 denote feature points. In the example illustrated in FIG. 10A, all blocks have some feature points 1001, and thus the unevenness degree is 0. On the other hand, in the example illustrated in FIG. 10B, there is no feature point in any of three blocks 1011 to 1013 on a left-hand side, while the other blocks include one or more feature points 1001. Thus, in this example, the unevenness degree is 3.

In a case where the right image is divided into 3×3 blocks (i.e., m=n=3), the judgment unit 15 may define the unevenness degree by the number of blocks including no feature point among 8 blocks excluding a block located at the center. When the block at the center includes no feature point, if neighboring blocks include feature points, then this means that feature points exist over a wide area of the right image and correction parameters are calculated using such feature points, and thus the feature points may be regarded as being distributed rather evenly.

Alternatively, the judgment unit 15 may equally divide the right image into two blocks in a horizontal or vertical direction, and may determine the number of feature points included in each block. The judgment unit 15 then may calculate the ratio of the number of feature points included in each of two blocks to the total number of feature points, and may define the unevenness degree by the ratio of a greater number of feature points to the total number of feature points.

Alternatively, the judgment unit 15 may calculate the unevenness degree according to an equation given below.

b=α·(|m−me|²/|me|²)+β|s−se|/|se| (4)

where b is the unevenness degree. In this equation, a function |a=(aₓ, a_{y})| is (aₓ²+a_{y}²)^{1/2}. α and β are coefficients satisfying a condition α≧0, β≧0, and α+β=1. For example, α=β=0.5. W and H respectively denote a horizontal width and a vertical height of the right image, and m=(m_{y}, m_{y}) denotes the average value of coordinates of feature points existing on the right image where mₓ denotes a horizontal average coordinate value and m_{y} denote a vertical average coordinate value. Furthermore, me=(W/2, H/2) denotes average coordinate values of feature points in a case in which feature points are uniformly distributed over the right image, i.e., the coordinates of the center of the image. Furthermore, s=(sᵣ, s_{y}) denotes variances of coordinates of feature points existing on the right image, where sₓ denotes a variance in a horizontal direction, and s_{y} denotes a variance in a vertical direction. Furthermore, se=(W²/12, H²/12) denotes expected values of the variances in a case where feature points are uniformly distributed over the entire right image. For example, the expected value of the variance in the horizontal direction is given by a following equation.

$$Expected value of variance of horizontal component = {\int }_{∞}^{∞ p ( n ) {( n \text{-} expected value of average of horizontal component )}^{2} d n} = {\int }_{0}^{W} \frac{1}{W} {( n - \frac{1}{2} W )}^{2} d n = \frac{1}{W} {\int }_{0}^{W} ( {n}^{2} - Wn + \frac{1}{4} {W}^{2} ) d n = {\frac{1}{W} [ \frac{1}{3} {n}^{3} - \frac{W}{2} {n}^{2} + \frac{{W}^{2}}{4} n ]}_{0}^{W} = \frac{1}{W} ( \frac{1}{3} {W}^{3} - \frac{1}{2} {W}^{3} + \frac{1}{4} {W}^{3} ) = ( \frac{1}{3} - \frac{1}{2} + \frac{1}{4} ) {W}^{2} = \frac{1}{12} {W}^{2} \qquad ( 5 )$$

where p(n) denotes a probability that a feature point has a horizontal coordinate of n. In the present embodiment, it is assumed that the feature points are uniformly distributed, and thus p(n) is 1/W regardless of the value of n. The expected value of the variance in the vertical direction is given by a similar equation.

The judgment unit 15 judges whether the calculated unevenness degree is equal to or smaller than a predetermined threshold value. When the unevenness degree is greater than the threshold value, it is judged that the set of correction parameters is not adequate for use in generating the stereo image, and the judgment unit 15 instructs the correction unit 14 to discard the set of correction parameters. On the other hand, in a case where the unevenness degree is equal to or smaller than the threshold value, the judgment unit 15 judges that the set of correction parameters is adequate for use in generating a stereo image and notifies the correction unit 14 of this judgment result. On receiving the notification, the correction unit 14 corrects at least either the subject image on the left image or the subject image on the right image according to the set of correction parameters thereby producing a stereo image. The threshold value in terms of the unevenness degree may be set, for example, to an upper limit of an allowable range of the unevenness degree within which a three-dimensional image displayed according to the stereo image generated using the set of correction parameters has acceptable high image quality. The upper limit of the unevenness degree, i.e., the threshold value in terms of the unevenness degree may be, for example, experimentally determined by producing an unevenness degree and a stereo image based on a plurality of sample data of a set of a left image and a right image.

The judgment unit 15 may use both the unevenness degree and the correction error in judging whether the set of correction parameters is adequate for use in generating a stereo image. For example, the judgment unit 15 may judge that the set of correction parameters is adequate for use in generating a stereo image only when the unevenness degree is equal to or smaller than the threshold value associated with the unevenness degree and the correction error is equal to or smaller than the threshold value associated with the correction error.

The judgment process described above is performed, for example, between step S105 and step S106 in the stereo image generation process illustrated in FIG. 8.

In this second embodiment, the stereo image generation apparatus judges whether the calculated set of correction parameters is adequate for use in generating a stereo image, and the stereo image generation apparatus uses the set of correction parameters in generating the stereo image when the set of correction parameters is adequate. This results in improvement in image quality of the stereo image generated by the stereo image generation apparatus.

Next, a stereo image generation apparatus according to a third embodiment is described below. In the stereo image generation apparatus according to the third embodiment, a set of correction parameter is calculated in a calibration process and the calculated set of correction parameter is stored. When a set of a left image and a right image is obtained thereafter, the stereo image generation apparatus corrects positions of a subject image of at least one of the left image and the right image using the set of correction parameters thereby generating a stereo image.

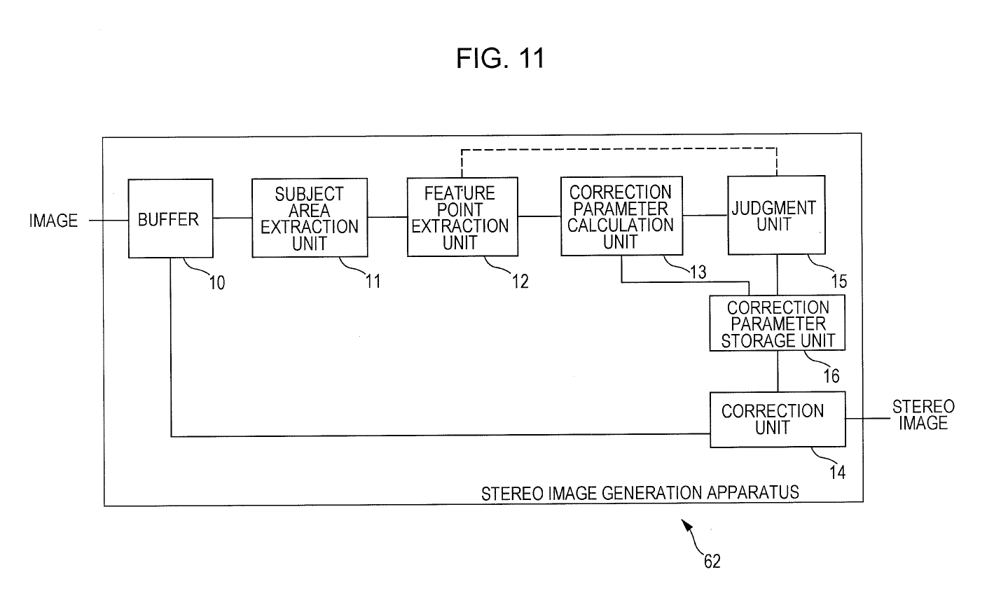

FIG. 11 illustrates a configuration of the stereo image generation apparatus according to the third embodiment. The stereo image generation apparatus 62 according to the third embodiment includes a buffer 10, a subject area extraction unit 11, a feature point extraction unit 12, a correction parameter calculation unit 13, a correction unit 14, a judgment unit 15, and a correction parameter storage unit 16. In FIG. 11, similar elements of the stereo image generation apparatus 62 to those of the stereo image generation apparatus 61 according to the second embodiment illustrated in FIG. 9 are denoted by similar reference numerals. The stereo image generation apparatus 62 according to the third embodiment is different from the stereo image generation apparatus 61 according to the second embodiment in terms of the correction parameter storage unit 16. Therefore, the following description focuses on the correction parameter storage unit 16 and associated parts. As to elements of the stereo image generation apparatus 62 other than the correction parameter storage unit 16, refer to descriptions of corresponding elements of the stereo image generation apparatus according to the first or second embodiment.

The correction parameter storage unit 16 includes, for example, a nonvolatile read-write semiconductor memory, and the correction parameter storage unit 16 stores the set of correction parameters received from the correction parameter calculation unit 13.

In the present embodiment, a set of correction parameters is determined by executing steps S101 to S105 in the operation flow chart illustrated in FIG. 8 when a calibration is performed on a digital camera on which the stereo image generation apparatus 62 is mounted. Thereafter, if the judgment unit 15 judges that the set of correction parameters is not adequate for use in generating a stereo image, the set of correction parameters is deleted from the correction parameter storage unit 16. The stereo image generation apparatus 62 repeats the process from step S101. On the other hand, in a case where the judgment unit 15 judges that the set of correction parameters is adequate for use in generating a stereo image, the stereo image generation apparatus 62 ends the calibration process.

When an image is taken in a normal mode, the stereo image generation apparatus 62 performs only steps S101, S102, and S106 without performing steps S103 to S105. More specifically, the stereo image generation apparatus 62 generates a left image and a right image each time the stereo image generation apparatus 62 receives an image of a subject captured using the stereo adapter 8 from the image capturing unit 2. The stereo image generation apparatus 62 corrects the positions of pixels of at least one of the left image and the right image according to Equation (3) using the set of correction parameters stored in the correction parameter storage unit 16 thereby generating a stereo image.

In this third embodiment, the stereo image generation apparatus does not have to calculate the set of correction parameter each time an image is taken, which results in a reduction in calculation processing load in generating a stereo image. In a case where a stereo image is generated from each of images provided time-sequentially as in taking a moving picture, the stereo image generation apparatus may also use the same set of correction parameters for the sequence of images. This results in a reduction in time-dependent change in relative positions between images of a subject subjected to the correction.

Next, a stereo image generation apparatus according to a fourth embodiment is described below. In the fourth embodiment, the stereo image generation apparatus calculates a set of correction parameters based on a preview image or the like with lower resolution than the resolution of an original image generated by the image capturing unit. In the stereo image generation apparatus, a projection transform matrix defined by the set of correction parameters determined based on the preview image is corrected based on a ratio of resolution between the preview image and the original image.

The stereo image generation apparatus according to the fourth embodiment includes the same constituent elements as those of the stereo image generation apparatus 6 according to the first e embodiment. However, the stereo image generation apparatus according to the fourth embodiment is different from the stereo image generation apparatus 6 according to the first embodiment in that a preview image is used in calculating a set of correction parameters and different in the configuration and operation of the correction unit 14. Therefore, the following description focuses on the correction unit 14 and the process of calculating correction parameters using the preview image. As to other elements of the stereo image generation apparatus, refer to descriptions of corresponding elements of the stereo image generation apparatus according to the first embodiment.

The stereo image generation apparatus receives, from the image capturing unit 2, an original image of a subject captured using the stereo adapter 8 and stores the received image in the buffer 10. The stereo image generation apparatus receives a preview image from the control unit 7 of the digital camera 1 and stores the received preview image in the buffer 10. For example, the preview image may be generated by the control unit 7 by thinning out pixels of the original image at particular intervals such that the preview image has a proper number of pixels capable of being displayed on the display unit 4. For example, when the original image has about 1900 pixels in a horizontal direction and about 1300 pixels in a vertical direction, the preview image may have 640 pixels in the horizontal direction and 480 pixels in the vertical direction. Thus, the preview image is smaller in data size than the original image.

The subject area extraction unit 11 extracts subject areas from a left-half area and a right-half area of the original image thereby generating a left image and a right image. Similarly, the subject area extraction unit 11 extracts subject areas from a left-half area and a right-half area of the preview image thereby generating a left image and a right image. Note that it is desirable that the left image and the right image generated from the preview image have the same aspect ratio as those of the left image and the right image generated from the original image. Furthermore, it is desirable that the area of the subject on the left image generated from the preview image is the same as that of the subject on the left image generated from the original image. Similarly, it is desirable that the area of the subject on the right image generated from the preview image is the same as that of the subject on the right image generated from the original image. The subject area extraction unit 11 stores the left image and the right image generated from the original image in the buffer 10. On the other hand, the subject area extraction unit 11 transfers the left image and the right image generated from the preview image to the feature point extraction unit 12. The feature point extraction unit 12 extracts a plurality of feature points from the left image and the right image generated from the preview image. The correction parameter calculation unit 13 calculates a set of correction parameters based on a plurality of sets of feature points extracted from the left image and the right image generated from the preview image. The set of correction parameters is transferred to the correction unit 14.

The correction unit 14 converts respective elements of a projection transform matrix obtained from the set of correction parameters depending on a ratio of the number of pixels between the preview image and the original image according to a following equation.

$${H}^{′} = ( \begin{matrix}{H}_{11} & {H}_{12} \cdot {R}_{h} / {R}_{v} & {H}_{13} \cdot {R}_{h} \\ {H}_{21} \cdot {R}_{v} / {R}_{h} & {H}_{22} & {H}_{23} \cdot {R}_{v} \\ {H}_{13} / {R}_{h} & {H}_{23} / {R}_{v} & {H}_{33 }\end{matrix} ) \qquad ( 6 )$$

where Hᵢⱼ (i, j=1, 2, 3) is an element in an i-th row and j-th column of the projection transform matrix obtained from the set of correction parameters calculated based on the preview image. The projection transform matrix may be a matrix obtained by combining the transformation matrix ARA⁻¹ and the transformation matrix R_{z} in Equation (3) into a single matrix. In Equation (3), the horizontal width W and the vertical height H of the image are given by the horizontal width and the vertical height of the original image. In Equation (6), Rₕ denotes the ratio of the number of pixels Nₕₒ in the horizontal direction included in the left image or the right image of the original image to the number of pixels Nₕₚ in the horizontal direction included in the left image or the right image extracted from the preview image, i.e., Rₕ is Nₕₒ/Nₕₚ. Similarly, Rᵥ denotes the ratio of the number of pixels Nᵥₒ in the vertical direction included in the left image or the right image of the original image to the number of pixels Nᵥₚ in the vertical direction included in the left image or the right image extracted from the preview image, i.e., Rₕ is Nᵥₒ/Nᵥₚ. H′ is a projection transform matrix obtained as a result of the conversion described above. Using the converted projection transform matrix, the correction unit 14 corrects the positions of pixels of at least one of the left image and right image extracted from the original image thereby generating a stereo image.

According to the present embodiment, the stereo image generation apparatus calculates the set of correction parameters based on the preview image including a less number of pixels than the original image includes. This results in a reduction in processing load in calculating the set of correction parameters.

According to a modification, the stereo image generation apparatus according to the second or third embodiment may calculate a set of correction parameters based on a preview image in a similar manner to the fourth embodiment described above.

According to another modification, the stereo image generation apparatus itself may generate a preview image by thinning out pixels of an original image at particular intervals and may calculate a set of correction parameters based on the generated preview image.

Next, a stereo image generation apparatus according to a fifth embodiment is described below. In this stereo image generation apparatus, once a set of correction parameters is calculated, the set of correction parameters is stored. When a set of correction parameters is again calculated later, the new set of correction parameters is compared with the stored set of correction parameters. If there is a difference greater than an upper allowable limit between the sets of correction parameters, a warning is given to a user.

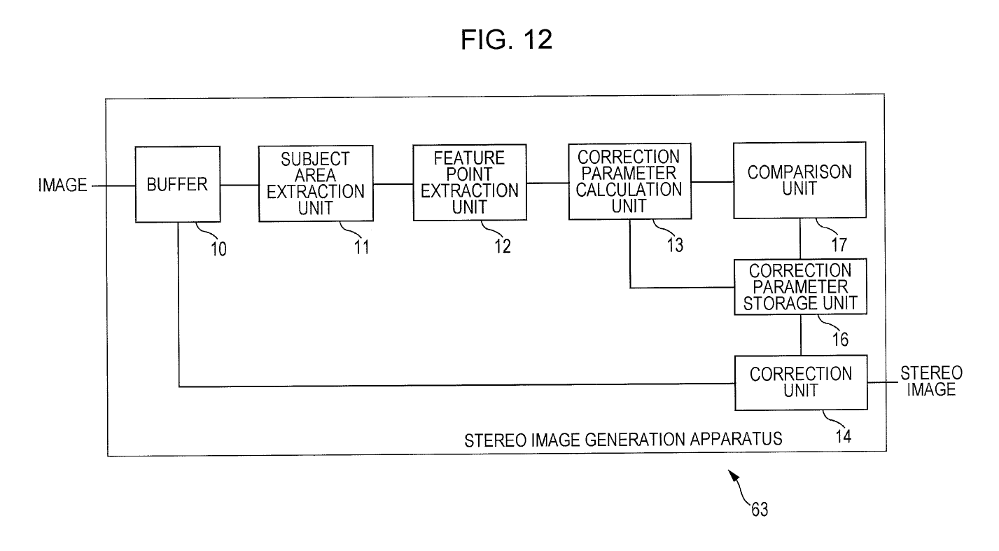

FIG. 12 illustrates a configuration of a stereo image generation apparatus according to the fifth embodiment. In the fifth embodiment, the stereo image generation apparatus 63 includes a buffer 10, a subject area extraction unit 11, a feature point extraction unit 12, a correction parameter calculation unit 13, a correction unit 14, a correction parameter storage unit 16, and a comparison unit 17. In FIG. 12, similar elements of the stereo image generation apparatus 63 to those of the stereo image generation apparatus 62 according to the third embodiment illustrated in FIG. 11 are denoted by similar reference numerals. The stereo image generation apparatus 63 according to the fifth embodiment is different from the stereo image generation apparatus 62 according to the third embodiment in that the judgment unit 15 is replaced by the comparison unit 17. Thus, the following description focuses on the comparison unit 17 and associated parts. As to elements of the stereo image generation apparatus 63 other than the comparison unit 17, refer to descriptions of corresponding elements of the stereo image generation apparatus according to the first or third embodiment.

At predetermined time intervals, the correction parameter calculation unit 13 periodically calculates a set of correction parameters based on an image supplied from the image capturing unit 2. The predetermine time interval may be, for example, one minute, one hour, one day, etc. Alternatively, each time electric power of the digital camera 1 is turned on, the correction parameter calculation unit 13 may calculate a set of correction parameters based on an image that is taken for the first time after the electric power is turned on in a state in which the stereo adapter 8 is mounted. The correction parameter calculation unit 13 transfers the calculated set of correction parameters to the comparison unit 17.

The comparison unit 17 compares the set of correction parameters received from the correction parameter calculation unit 13 with the set of correction parameters that were calculated before and stored in the correction parameter storage unit 16. Hereinafter, for convenience, the set of correction parameters stored in the correction parameter storage unit 16 is referred to as an old set of correction parameters and the set of correction parameters received from the correction parameter calculation unit 13 is referred to as a current set of correction parameters.

In a case where the comparison made by the comparison unit 17 indicates that the difference of the absolute value between a correction parameter in the old set of correction parameters and the absolute value of a correction parameter in the current set of correction parameters is equal to or smaller than a predetermined threshold value for any of correction parameters, the comparison unit 17 stores the current set of correction parameters in the correction parameter storage unit 16 thereby updating the set of correction parameters.

In a case where the difference of absolute value between any correction parameter in the old set of correction parameters and a corresponding correction parameter in the current set of correction parameters is greater than the predetermined threshold value, the comparison unit 17 determines that the stereo adapter 8 has changed by aging from the state in which the old set of correction parameters was calculated or a change has occurred in mounting position of the stereo adapter on the digital camera. The threshold value may be set, for example, to an upper limit of the absolute value of the difference that does not cause a user to perceive a change in image quality of a generated stereo image. The comparison unit 17 notifies the control unit 7 of the digital camera 1 of the judgment result. The control unit 7 displays, on the display unit 4, a message indicating that the stereo adapter 8 has changed by aging or a change has occurred in mounting position of the stereo adapter on the digital camera, and a message to prompt a user to select whether the current set of correction parameters is to be used. If the user operates the operation unit 3 to select the current set of correction parameters, then the operation unit 3 sends a control signal to the control unit 7 to notify that the current set of correction parameters is selected to be used. In response, the control unit 7 notifies the stereo image generation apparatus 63 of this selection. In this case, the comparison unit 17 stores the current set of correction parameters in the correction parameter storage unit 16 thereby updating the set of correction parameters.

On the other hand, in a case where the operation unit 3 sends a control signal to the control unit 7 to notify that the current set of correction parameters is determined not to be used, the control unit 7 notifies the stereo image generation apparatus 63 of this selection. In this case, the comparison unit 17 discards the current set of correction parameters and the stereo image generation apparatus 63 does not update the set of correction parameters. The control unit 7 may display, on the display unit 4, a message suggesting to check the mounting position of the stereo adapter 8.

Each time the stereo image generation apparatus 63 receives an image from the image capturing unit 2, the correction unit 14 reads out the set of correction parameters stored in the correction parameter storage unit 16. The correction unit 14 corrects the positions of pixels of at least one of the left image and right image by using a projection transform matrix obtained, for example, by substituting the set of correction parameters into Equation (3) thereby generating a stereo image.

According to the present embodiment, the stereo image generation apparatus is capable of detecting a shift of the mounting position of the stereo adapter or degradation of the stereo adapter by aging by comparing the new set of correction parameters with the set of correction parameters produced in the past. Thus, in this stereo image generation apparatus, when a change in the mounting position of the stereo adapter or the like occurs which affects the set of correction parameters, it is possible to keep the inadequate correction parameters away from being further used in generating a stereo image.

According to a modification to the embodiments, in a case where the stereo adapter has a high-precision mounting mechanism that allows the stereo adapter to be mounted on the image capturing unit with a negligibly small mounting position error, the feature point extraction unit may calculate the evaluation value e(x, y, yₓ, v_{y}) according to the following equation instead of Equation (1) or (2).

e(x,y,vₓ,v_{y})=s(x,y,vₓ,v_{y})+α·g(|vₓ−vₓₜₕ₂|)+β·g(|v_{y}−v_{yth2}|) (7)

where g(a) is a monotonically decreasing function whose outputs relatively decreases with increasing variable a. For example, g(a)=1/(1+a). In Equation (7), an amount of shift in the horizontal direction vₓₜₕ₂ and an amount of shift v_{yth2} in the vertical direction due to differences in distortion of a subject image between the left image and the right image caused by the structure of the stereo adapter are set in advance for each pixel on the left image.

All or part of the functions of the stereo image generation apparatus according to one of embodiments or modifications thereto described above may be realized by a computer program executed on a processor. Such a computer program may be provided via a storage medium such as a magnetic storage medium, an optical storage medium, or the like in which the computer program is stored.

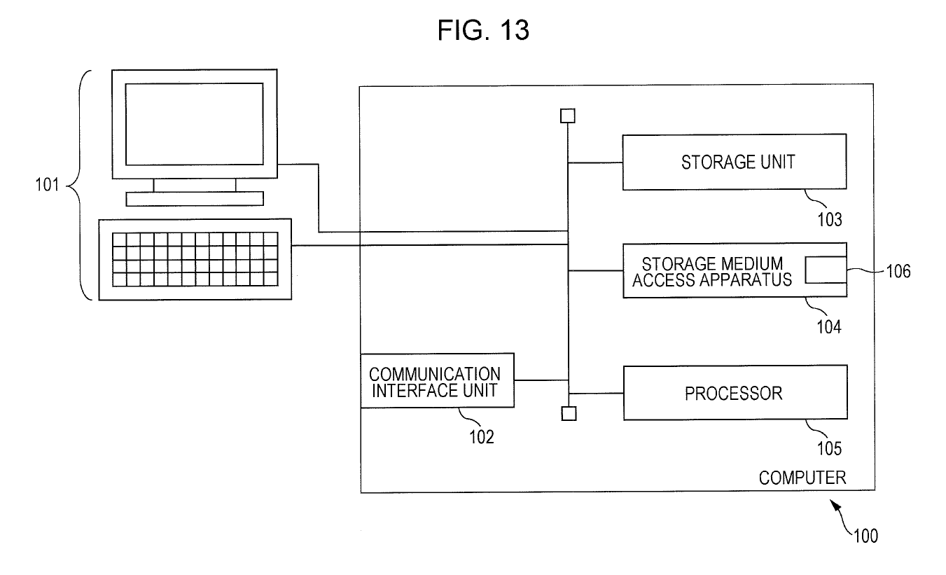

FIG. 13 illustrates a configuration of a computer that operates as a stereo image generation apparatus by executing a computer program to implement functions of the stereo image generation apparatus according to one of embodiments or modifications thereto described above. The computer 100 includes a user interface unit 101, a communication interface unit 102, a storage unit 103, a storage medium access apparatus 104, and a processor 105. The processor 105 is connected, via, for example, a bus, to the user interface unit 101, the communication interface unit 102, the storage unit 103, and the storage medium access apparatus 104.

The user interface unit 101 includes, for example, an input device such as a keyboard, a mouse, etc., and a display apparatus such as a liquid crystal display. Alternatively, the user interface unit 101 may include an apparatus such as a touch panel display in which an input device and a display apparatus are integrally formed. For example, in response to an operation performed by a user, the user interface unit 101 outputs an operation signal to the processor 105 to start a process of generating a stereo image.

The communication interface unit 102 may include a communication interface and a control circuit thereof to connect the computer 100 to an image pickup apparatus (not illustrated) to which a stereo adapter is removably attached. For example, an USB (Universal Serial Bus) interface may be employed as the above-described communication interface. The communication interface unit 102 may also include a communication interface and a control circuit thereof to connect to a communication network according to a communication standard such as Ethernet (registered trademark). In this case, the communication interface unit 102 may acquire an image of a subject taken using a stereo adapter from an image pickup apparatus, a camera, or another device connected to the communication network and the communication interface unit 102 may transfer the acquired image to the processor 105. The communication interface unit 102 may output a stereo image received from the processor 105 to another device via the communication network.

The storage unit 103 includes, for example, a read-write semiconductor memory and a read-only semiconductor memory. The storage unit 103 stores a computer program to be executed on the processor 105 to perform the stereo image generation process and also stores data used in the stereo image generation process, such as parameters vₓₜₕ₁, v_{yth1}, vₓₜₕ₂, and v_{yth2} indicating estimated amounts of shifting of a subject image on the right image with respect to a subject image on the left image. The storage unit 103 also stores an image received via the communication interface unit 102 a stereo image generated by the processor 105, etc.

The storage medium access apparatus 104 is an apparatus configured to access the storage medium 106. Examples of the storage medium access apparatus 104 include a magnetic disk, a semiconductor memory card, an optical storage medium, etc. For example, the storage medium access apparatus 104 reads a computer program, that is to be executed on the processor 105 to perform the stereo image generation process, from the storage medium 106 and transfers the read computer program to the processor 105. The storage medium access apparatus 104 may write a stereo image generated by the processor 105 in the storage medium 106.

The processor 105 executes the computer program to perform the stereo image generation process according to one of embodiments or modifications described above thereby generating a stereo image from the image of the subject taken using the stereo adapter. The processor 105 stores the generated stereo image in the storage unit 103 or outputs the generated stereo image to another device via the communication interface unit 102.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A stereo image generation apparatus comprising:
a subject area extraction unit configured to extract, from an image, a first area including a first image of the subject generated by one of two light beams and a second area including a second image of the subject generated by the other one of the two light beams, the image being captured by using a stereo adaptor configured to split light from the subject into two light beams and direct the two light beams to an image capturing unit;
a feature point extraction unit configured to extract a plurality of sets of feature points from the first area and the second area such that each set of feature points corresponds to the same one of points on the subject;
a correction parameter calculation unit configured to calculate, based on the plurality of sets of feature points, at least one correction parameter according to which aligns the image of the subject on the first area and the image of the subject on the second area with respect to each other;
a correction unit configured to correct, using the correction parameter, either one of both of the image of the subject on the first area and the image of the subject on the second area thereby generating a stereo image,
wherein the feature point extraction unit is configured to extract the sets of feature points by
extracting a first feature point from the first area, determining a position on the image of the subject in the second area, the position being identified by projecting the first feature point in the subject on the first area depending on a structure of the stereo adaptor and a coordinate of the first feature point, and the position being defined as a base point,
defining a possible shifting area within which further shifting from the base point due to a positioning error in case of mounting the stereo adapter on the image capturing unit may occur on a point on the image of the subject in the second area in addition to the shifting from a corresponding point on the image of the subject in the first area due to the structure of the stereo adapter,
calculating an evaluation value for a plurality of points in the second area according to an evaluation function which is high when a point of interest exits within the possible shifting area and which increases with increasing similarity of the point of interest with a neighboring area of the first feature point,
detecting a point having a highest evaluation value and employing the detected point as a second feature point, and
combining the first feature point and the second feature point into a set thereby obtaining the set of feature points.

2. A method for generating a stereo image, the method comprising:
capturing an image generated by using a stereo adaptor configured to split light from a subject into two light beams and direct the two light beams to an image capturing unit;
extracting a first area including a first image of the subject generated by one of two light beams and a second area including a second image of the subject generated by the other one of the two light beams;
extracting a plurality of sets of feature points from the first area and the second area such that each set of feature points corresponds to the same one of points on the subject;
calculating, based on the plurality of sets of feature points, at least one correction parameter in order to align the image of the subject on the first area and the image of the subject on the second area with respect to each other;
generating the stereo image by correcting, using the correction parameter, either one of both of the image of the subject on the first area and the image of the subject on the second area,
wherein the extracting the plurality of sets of feature points includes,
extracting a first feature point from the first area, determining a position on the image of the subject in the second area to which the image of the subject in the first area is shifted depending on a coordinate of the first feature point and depending on a structure of the stereo adapter and defining the position as a base point,
defining a possible shifting area within which further shifting from the base point due to a positioning error in mounting the stereo adapter on the image capturing unit may occur on a point on the image of the subject in the second area in addition to the shifting from a corresponding point on the image of the subject in the first area due to the structure of the stereo adapter,
calculating an evaluation value for a plurality of points in the second area according to an evaluation function which is high when a point of interest exits within the possible shifting area and which increases with increasing similarity of the point of interest with a neighboring area of the first feature point,
detecting a point having a highest evaluation value and employing the detected point as a second feature point, and
combining the first feature point and the second feature point into a set thereby obtaining the set of feature points.

3. A computer-readable recording medium storing a program that causes a computer to execute a procedure comprising:
extracting, from an image, a first area including a first image of the subject generated by one of two light beams and a second area including a second image of the subject generated by the other one of the two light beams, the image being captured by using a stereo adaptor configured to split light from the subject into two light beams and direct the two light beams to an image capturing unit;
extracting a plurality of sets of feature points from the first area and the second area such that each set of feature points corresponds to the same one of points on the subject;
calculating, based on the plurality of sets of feature points, at least one correction parameter according to which aligns the image of the subject on the first area and the image of the subject on the second area with respect to each other;
correcting, using the correction parameter, either one of both of the image of the subject on the first area and the image of the subject on the second area thereby generating a stereo image,
wherein the extracting the plurality of sets of feature points extracts the sets of feature points by
extracting a first feature point from the first area, determining a position on the image of the subject in the second area, the position being identified by projecting the first feature point in the subject on the first area depending on a structure of the stereo adaptor and a coordinate of the first feature point, and the position being defined as a base point,
defining a possible shifting area within which further shifting from the base point due to a positioning error in case of mounting the stereo adapter on the image capturing unit may occur on a point on the image of the subject in the second area in addition to the shifting from a corresponding point on the image of the subject in the first area due to the structure of the stereo adapter,
calculating an evaluation value for a plurality of points in the second area according to an evaluation function which is high when a point of interest exits within the possible shifting area and which increases with increasing similarity of the point of interest with a neighboring area of the first feature point,
detecting a point having a highest evaluation value and employing the detected point as a second feature point, and
combining the first feature point and the second feature point into a set thereby obtaining the set of feature points.

4. A stereo image capturing apparatus comprising:
an image capturing unit configured to generate an image by capturing a subject;
a stereo adapter disposed in front of the image capturing unit and configured to split light from the subject into two light beams and direct the two light beams to the image capturing unit thereby generating two sub images of the subject on the image;
a stereo image generation unit configured to generate a stereo image based on the two sub images of the subject formed on the image,
the stereo image generation unit including
a subject area extraction unit configured to extract, from the image, a first area including an image of the subject generated by one of the two light beams and a second area including an image of the subject generated by the other one of the two light beams;
a feature point extraction unit configured to extract a plurality of sets of feature points from the first area and the second area such that each set of feature points corresponds to the same one of points on the subject;
a correction parameter calculation unit configured to calculate, based on the plurality of sets of feature points, at least one correction parameter according to which to align the image of the subject on the first area and the image of the subject on the second area with respect to each other; and
a correction unit configured to correct, using the correction parameter, either one of both of the image of the subject on the first area and the image of the subject on the second area thereby generating a stereo image,
the feature point extraction unit being configured to extract the sets of feature points by
extracting a first feature point from the first area, determining a position on the image of the subject in the second area to which the image of the subject in the first area is shifted depending on a coordinate of the first feature point and depending on a structure of the stereo adapter and defining this position as a base point,
defining a possible shifting area within which further shifting from the base point due to a positioning error in mounting the stereo adapter on the image capturing unit may occur on a point on the image of the subject in the second area in addition to the shifting from a corresponding point on the image of the subject in the first area due to the structure of the stereo adapter,
calculating an evaluation value for a plurality of points in the second area according to an evaluation function which is high when a point of interest exits within the possible shifting area and which increases with increasing similarity of the point of interest with a neighboring area of the first feature point,
detecting a point having a highest evaluation value and employing the detected point as a second feature point, and
combining the first feature point and the second feature point into a set thereby obtaining the set of feature points.
